(19) United States
(12) Patent Application Publication
(10) Pub. No.: US 2023/0278506 A1
(43) Pub. Date: Sep. 7, 2023

(54) VEHICLE LOWER STRUCTURE

(71) Applicant: HONDA MOTOR CO., LTD., Tokyo (JP)

(72) Inventor: Hidefumi NIHEI, Tokyo (JP)

(21) Appl. No.: 18/174,907

(22) Filed: Feb. 27, 2023

(30) Foreign Application Priority Data
Mar. 3, 2022 (JP) 2022-032280

(51) Int. Cl. B60R 13/08; B62D 25/20; F01N 1/24

(52) U.S. Cl. CPC B60R 13/08; B62D 25/20; F01N 1/24

(57) ABSTRACT

A vehicle lower structure is provided with an underbody cover installed to cover a vehicle body lower surface from below, a noise insulating material laid on an upper surface of the underbody cover, and a locking member fixed to the underbody cover while being laid on the noise insulating material.

### CROSS-REFERENCE TO RELATED APPLICATION

This application is based upon and claims priority from Japanese Patent Application No. 2022-032280, filed on Mar. 3, 2022, the entire contents of which are incorporated herein by reference.

### BACKGROUND OF THE INVENTION

### 1. Field of the Invention

The present invention relates to a vehicle lower structure including an underbody cover forming a vehicle body lower surface.

### 2. Description of the Related Art

An underbody cover has been conventionally installed on a lower surface of a vehicle body to smooth air flow on the vehicle body lower surface while a vehicle is traveling and improve an aerodynamic performance of the vehicle.

Moreover, a noise insulating material is installed on the underbody cover to reduce noise in the vehicle while the vehicle is traveling.

For example, JP2002-087180A proposes a configuration in which a resin material is foamed and cured on an underbody cover provided with multiple protrusions to be engaged and fixed to the protrusions, and is used as a noise insulating material.

### SUMMARY OF THE INVENTION

In such a configuration, for example, when the vehicle travels on a puddle and water enters a gap between the vehicle body lower surface and the underbody cover, the noise insulating material may detach from the underbody cover due to the momentum of the entering water.

Particularly, when the noise insulating material has become brittle due to aging, such detachment tends to notably occur.

The present invention has been made in view of the aforementioned points, and an object is to provide a vehicle lower structure that can suppress detaching of the noise insulating material.

In order to achieve the aforementioned object, a vehicle lower structure according to the present invention includes an underbody cover installed to cover a vehicle body lower surface from below, a noise insulating material laid on an upper surface of the underbody cover, and a locking member fixed to the underbody cover while being laid on the noise insulating material.

The present invention can provide a vehicle lower structure that can suppress detaching of a noise insulating material.

### BRIEF DESCRIPTION OF THE DRAWINGS

FIG. 1 is a perspective view showing an underbody cover forming a vehicle lower structure of the present embodiment.

FIG. 2 is a plan view showing a side cover.

FIG. 3 is a cross-sectional view along the line in FIG. 2.

FIG. 4 is a cross-sectional view along the IV-IV line in FIG. 2.

### DETAILED DESCRIPTION OF THE EMBODIMENTS

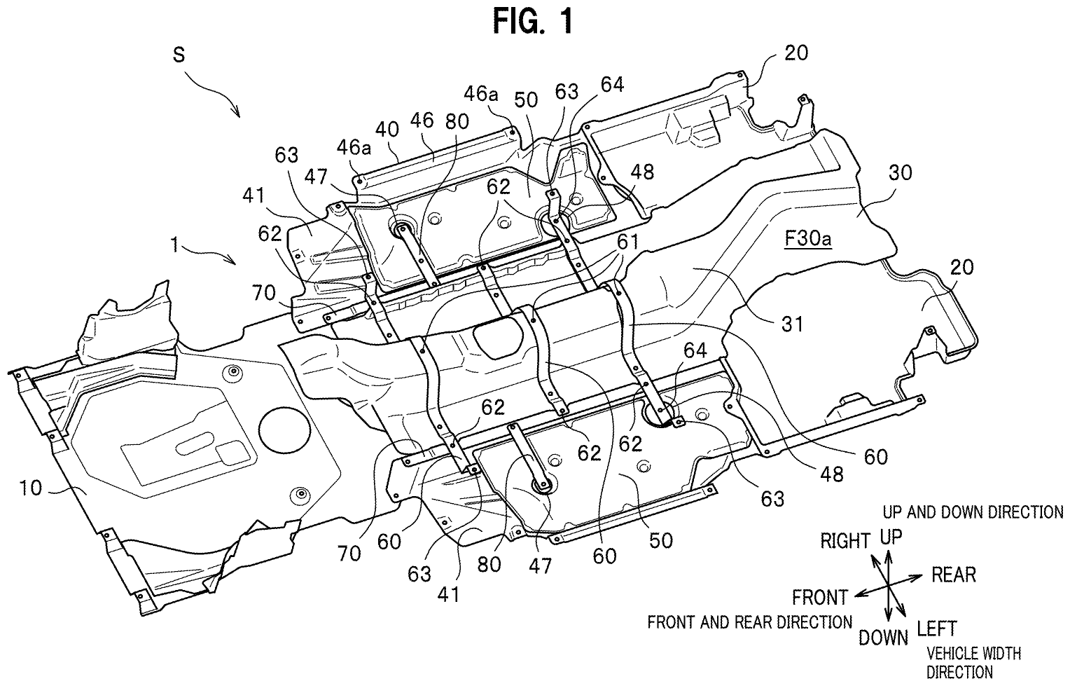

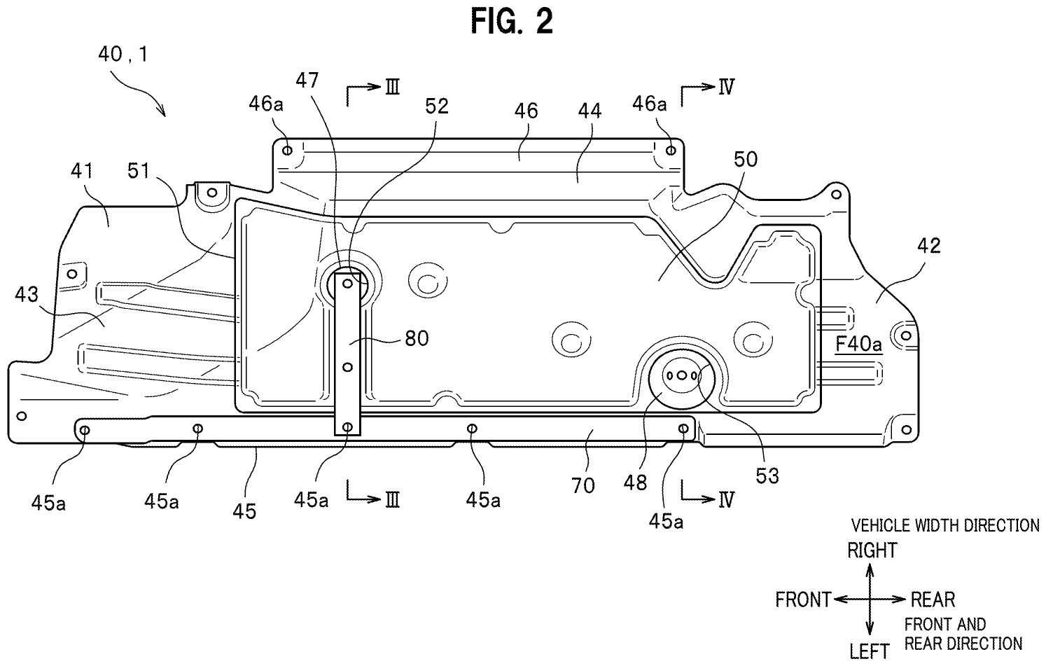

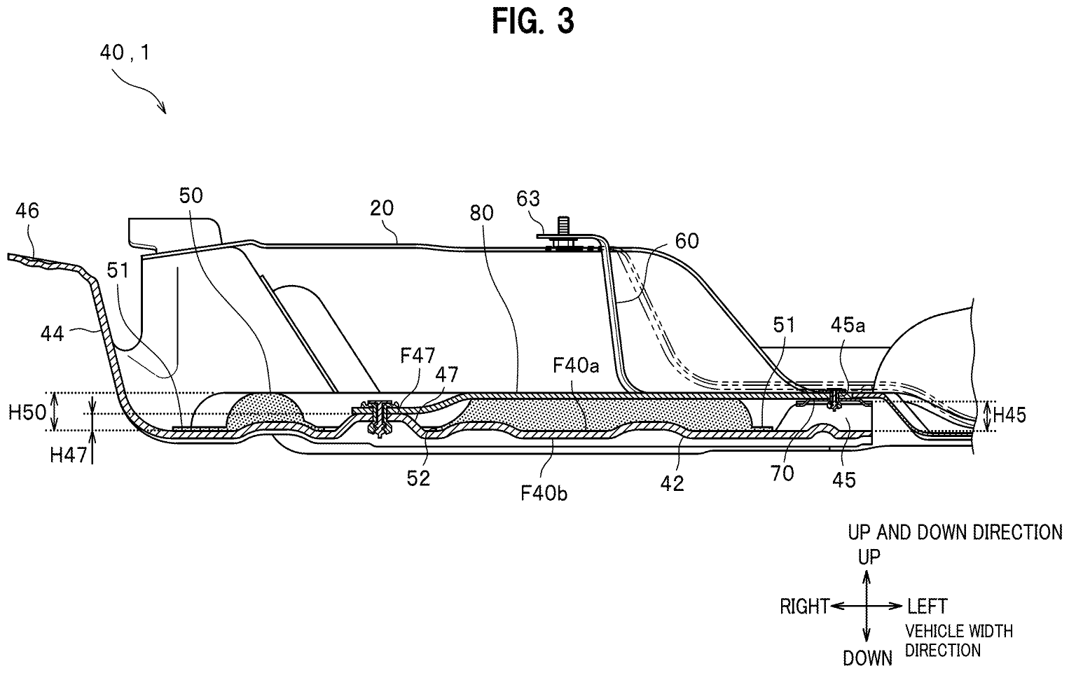

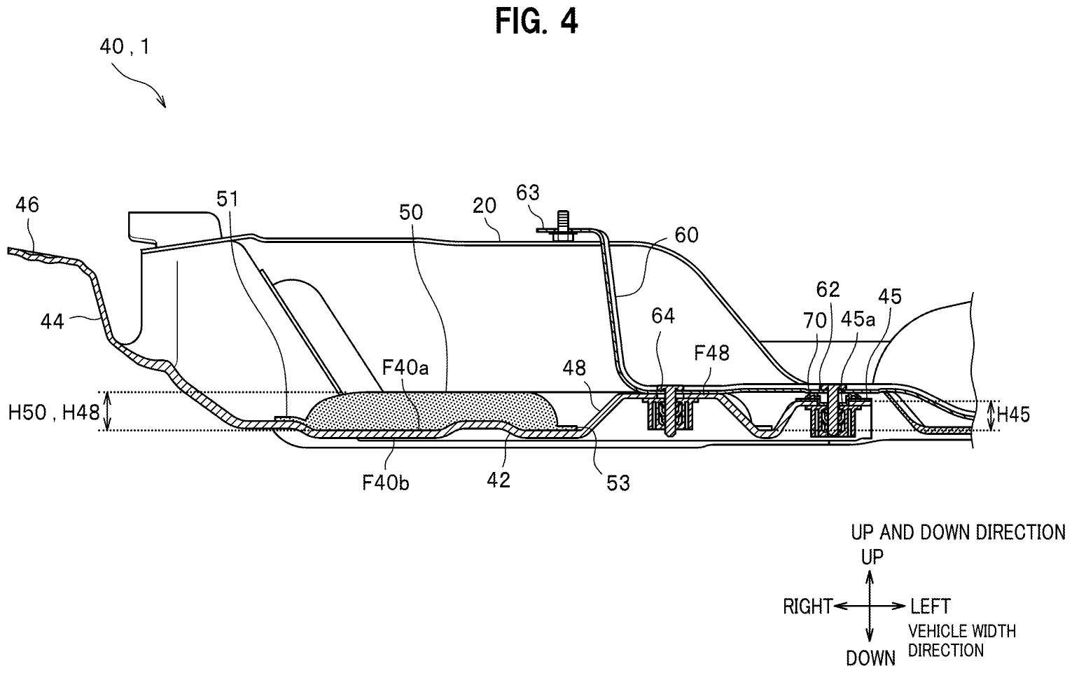

A vehicle lower structure S in one embodiment of the present invention is described in detail with reference to FIGS. 1 to 4.

Note that, in the following description, the same elements are denoted by the same reference signs, and overlapping description is omitted.

Moreover, “front”, “rear”, “upper”, “lower”, “inner”, and “outer” in the following description are assumed to mean “front” and “rear” in a vehicle front-rear direction, “upper” and “lower” in a vehicle upper-lower direction, and “inner” and “outer” in the vehicle inner side and the vehicle outer side, unless otherwise noted.

The vehicle lower structure S of the present embodiment includes an underbody cover 1 on a lower surface of a vehicle body (see FIG. 1)

The underbody cover 1 is provided for a purpose of smoothing disturbed air flowing under a floor while the vehicle is traveling and improving aerodynamic characteristics of the vehicle by allowing the entire vehicle body lower surface to be one flat surface.

The underbody cover 1 is formed of a plate shaped resin material, and is arranged such that plate surfaces face the upper-lower direction.

Since there are protrusions and recesses of various shapes on the vehicle body lower surface, a gap between the underbody cover 1 and the vehicle body lower surface is not uniform, and varies depending on locations.

The underbody cover 1 includes a front cover 10, rear covers 20, a center cover 30, and side covers 40 (see FIG. 1).

Moreover, a noise insulating material 50 is installed on an upper surface of the underbody cover 1.

Furthermore, the underbody cover 1 is fixed to the lower surface of the vehicle body via attachment brackets 60.

The front cover 10 is set in front of a vehicle cabin (not shown), and forms a bottom surface of a so-called engine room in which devices such as an engine (not shown) are housed.

The rear covers 20 are set as a pair of left and right covers in a rear portion of the vehicle cabin, and forms a bottom surface of seats in a second row and behind.

The center cover 30 is arranged between the left and right rear covers 20 while being continuous with a rear end portion of the front cover 10, and forms a vehicle width direction center portion in a floor surface of the vehicle cabin.

Moreover, the center cover 30 includes a tunnel groove 31 following a shape of a center tunnel in a floor panel.

The side covers 40 are set as a pair of left and right covers, and are continuous with front end portions of the rear covers 20 while being continuous with the vehicle width direction outer sides of the center cover 30 behind the front cover 10 (see FIGS. 1 to 4).

Moreover, the side covers 40 are set in a front portion of the vehicle cabin, and form a bottom surface of seats in a first row.

Specifically, the left and right side covers 40, the center cover 30, and the rear covers form a flat surface below the floor panel forming the floor surface of the vehicle cabin.

Each of the side covers 40 includes a front fixation portion 41, a side cover main body 42, a front tilted wall 43, a side closing wall 44, a first flange portion 45, and a second flange portion 46.

Note that the left and right side covers 40 are formed in shapes symmetric to each other with respect to the center cover 30.

Accordingly, in the present embodiment, the right side cover 40 is described, and description of the left side cover 40 is omitted by denoting parts thereof by the same reference signs as those in the right side cover 40.

The front fixation portion 41 is a configuration for fixing a front portion of the side cover 40 to the vehicle body.

The front fixation portion 41 is fixed by abutting the vehicle body lower surface located behind a tire house.

The side cover main body 42 is formed of a plate shaped member, and is arranged with a gap provided between itself and the vehicle body lower surface.

The noise insulating material 50 is installed on an upper surface F40a of the side cover main body 42.

A lower surface F40b of the side cover main body 42 forms a substantially horizontal flat surface continuous with the front cover 10, the center cover 30, and the rear covers 20.

Moreover, the side cover main body 42 is provided with a third fixation portion 47 and a fourth fixation portion 48.

The third fixation portion 47 is set in a portion of the side cover main body 42 that is continuous with the front tilted wall 43 and that is an outer peripheral portion (see FIGS. 1 to 3).

The third fixation portion 47 is formed of a protrusion having a substantially circular truncated cone shape cross section that protrudes upward from the side cover main body 42.

The height H47 of the third fixation portion 47 is set to a dimension that is about half the thickness H50 of the noise insulating material 50.

The fourth fixation portion 48 is set in an inner peripheral edge portion of the side cover main body 42, behind the third fixation portion 47 (see FIGS. 1, 2, and 4).

The fourth fixation portion 48 is formed of a protrusion having a substantially circular truncated cone shape cross section that protrudes upward from the side cover main body 42.

The height H48 of the fourth fixation portion 48 is set to a dimension that is almost the same as the thickness H50 of the noise insulating material 50.

The front tilted wall 43 closes a gap created by a height difference between the front fixation portion 41 and the side cover main body 42 with a tilted wall.

The front tilted wall 43 is tilted downward while extending toward the rear side.

The side closing wall 44 extends in the front-rear direction while standing upward from a vehicle width direction outer side edge of the side cover main body 42.

Moreover, the side closing wall 44 closes a gap between the side cover main body 42 and the vehicle body lower surface.

Specifically, the side closing wall 44 extends in the front-rear direction while being continuous with the vehicle width direction outer side edge of the side cover main body 42 and facing the vehicle width direction outer side edge in the vehicle width direction.

The first flange portion 45 is set as a portion for connecting the side cover 40 to the center cover 30.

The first flange portion 45 is formed of a long plate shaped piece that extends in the front-rear direction while facing in the upper-lower direction, in a vehicle width direction inner side edge of the side cover main body 42.

Moreover, the first flange portion 45 is provided to be offset upward from an upper surface of the side cover main body 42 by a dimension H45 that is about the same as the thickness H50 of the noise insulating material 50.

First fixation portions 45a are provided in the first flange portion 45.

A reinforcement plate 70 is installed in the first flange portion 45.

The first fixation portions 45a are formed of through-holes penetrating the first flange portion 45 in the upper-lower direction.

The reinforcement plate 70 is formed of a long plate shaped metal member that has a similar width dimension to the first flange portion 45 (see FIGS. 1 to 4).

The reinforcement plate 70 is fixed to the first flange portion 45 at the first fixation portions 45a while being laid on the upper surface of the first flange portion 45 along the front-rear direction.

The second flange portion 46 is set as a portion where the side cover 40 is fixed to the lower surface of the vehicle body.

The second flange portion 46 is formed of a long plate shaped piece extending in the front-rear direction while facing in the upper-lower direction, at an upper edge of the side closing wall 44.

Second fixation portions 46a are provided in the second flange portion 46.

The second fixation portions 46a are formed of through-holes penetrating the second flange portion 46 in the upper-lower direction, and are arranged in a front end portion and a rear end portion of the second flange portion 46.

The second fixation portions 46a are fixed to the vehicle body lower surface by fastening means such as bolts (not shown).

The noise insulating material 50 is formed of a felt-like non-woven sheet in which cotton-like fiber is stacked at a predetermined density to a predetermined thickness (see FIGS. 1 to 4).

The noise insulating material 50 is held by a locking member 80 while being attached to the upper surface F40a of the side cover 40 corresponding to a floor lower portion of a vehicle cabin with adhesive.

Moreover, in the noise insulating material 50, compressed portions 51 are formed in a peripheral edge portion and predetermined portions of the non-woven sheet.

Furthermore, a third fixation hole 52 and a fourth fixation hole 53 are opened in the noise insulating material 50.

The third fixation hole 52 is formed of a through-hole set in a portion overlapping the third fixation portion 47 of the side cover 40.

Moreover, a hole diameter of the third fixation hole 52 is set to such a dimension that a top surface F47 of the circular truncated cone of the third fixation portion 47 is exposed.

The fourth fixation hole 53 is formed of a through-hole set in a portion overlapping the fourth fixation portion 48 of the side cover 40.

The third fixation hole 52 engages with the third fixation portion 47 while the fourth fixation hole 53 engages with the fourth fixation portion 48, and the position of the noise insulating material 50 on the side cover 40 is thereby determined.

The compressed portions 51 are hardened by a press forming process (compressing process) performed on the peripheral edge portion of the non-woven sheet forming the noise insulating material 50.

Hardening the peripheral edge portion of the non-woven sheet can improve the rigidity of the noise insulating material 50 and suppress peeling or detaching of the noise insulating material 50 due to entering water.

The locking member 80 is set as a configuration for holding the noise insulating material 50 on the side cover 40 even when the adhesive fixing the noise insulating material 50 fails (see FIGS. 1 to 4).

The locking member 80 is formed of a long plate shaped metal member that has a similar width dimension to the reinforcement plate 70.

The locking member 80 is fixed to the side cover 40 while being laid on the noise insulating material 50.

An inner end portion of the locking member 80 is fixed to one of the first fixation portions 45a of the first flange portion 45 together with the reinforcement plate 70.

An outer end portion of the locking member 80 is fixed to the top surface F47 of the third fixation portion 47 through the third fixation hole 52 of the noise insulating material 50.

The locking member 80 is installed to the side cover 40 while slightly squashing the noise insulating material 50.

The attachment brackets 60 are set as configurations for fixing the underbody cover 1 to the lower surface of the vehicle body (see FIGS. 1, 3, and 4).

The attachment brackets 60 are made of long plate shaped metal materials extending in the vehicle width direction.

The attachment brackets 60 are installed at three locations in a portion under the floor of the seats in the first row (in front of the rear cover 20) at predetermined intervals in the front-rear direction.

Each of the attachment brackets 60 is formed to be left-right symmetric, and includes a center fixation portion 61 and flange fixation portions 62.

Moreover, each of the front and rear attachment brackets 60 includes vehicle body fixation portions 63.

Furthermore, the rear attachment bracket 60 includes side cover fixation portions 64.

The center fixation portion 61 is fixed to a tunnel groove 31 portion in the center cover 30.

The center fixation portion 61 is installed on an upper surface F30a of the center cover 30 while being bent to follow an uneven shape of the tunnel groove 31 portion.

Each attachment bracket 60 serves as a liner of the center cover 30, and reinforces the center cover 30 in the vehicle width direction.

Each flange fixation portion 62 is provided in a portion overlapping the first flange portion 45 of the side cover 40.

The flange fixation portion 62 is fixed to a side edge portion of the center cover 30, the first flange portion 45 of the side cover 40, and the reinforcement plate 70.

Each vehicle body fixation portion 63 is provided in an upper end portion bent upward from the outer side of the flange fixation portion 62.

The vehicle body fixation portion 63 is fixed to the lower surface of the vehicle body.

Each side cover fixation portion 64 is provided between the flange fixation portion 62 and the vehicle body fixation portion 63, and are fixed to a top surface F48 of the fourth fixation portion 48.

### <Steps of Attaching Underbody Cover>

Next, steps of attaching the underbody cover 1 are described.

First, the noise insulating material 50 and the locking member 80 are attached to the upper surface F40a of the side cover 40.

Moreover, the center fixation portions 61 of the attachment brackets 60 are attached to the center cover 30.

Next, the vehicle body fixation portions 63 of the attachment brackets 60 are fixed to the lower surface of the vehicle body, and the center cover 30 is attached to the vehicle body lower surface.

Then, the first fixation portions 45a of the side cover 40 are fixed to the flange fixation portions 62, and the fourth fixation portion 48 is fixed to the side cover fixation portions 64.

Note that, when the first fixation portions 45a of the side cover 40 are fixed to the flange fixation portions 62, a side edge portion of the center cover, an inner end portion of the locking member 80, and the reinforcement plate 70 are fastened together.

Moreover, the second fixation portions 46a of the second flange portion 46 are attached to the vehicle body lower surface, and attachment work of the center cover 30 and the side cover 40 is completed.

Thereafter, the front cover 10 and the rear cover 20 are attached.

Next, operations and effects of the present embodiment are described.

In the vehicle lower structure S of the present embodiment, the noise insulating material 50 is laid on the upper surface of the side cover main body 42 forming the underbody cover 1.

Then, the locking member 80 is fixed to the side cover 40 while being laid on the noise insulating material 50.

Such a configuration allows the locking member 80 to hold the noise insulating material 50 on the underbody cover 1 even when the adhesive fails due to aging or the like.

This can prevent the noise insulating material 50 from peeling off from the underbody cover 1.

Moreover, in the present embodiment, the inner end portion of the locking member 80 is fixed to one of the first fixation portions 45a while the outer end portion of the locking member 80 is fixed to the third fixation portion 47.

In such a configuration, the noise insulating material 50 is not detached from the underbody cover 1 unless the noise insulating material 50 breaks.

The noise insulating material 50 can be thereby more surely held on the underbody cover 1.

Furthermore, since the locking member 80 connects the third fixation portion 47 to the first flange portion 45 or the second flange portion 46, the rigidity of the locking member 80 can prevent the underbody cover 1 from sagging due to gravity.

Moreover, the present embodiment includes the fourth fixation portion 48 of the side cover 40 forming the underbody cover 1.

Furthermore, in the noise insulating material 50, the fourth fixation hole 53 is opened in the portion overlapping the fourth fixation portion 48.

Such a configuration allows the fourth fixation hole 53 to engage with the fourth fixation portion 48, and can further prevent peeling-off of the noise insulating material 50 from the underbody cover 1.

For example, when water enters a gap between the underbody cover 1 and the vehicle body lower surface, water enters the gap more frequently from the vehicle front side.

Moreover, in reversing of the vehicle where water enters the gap from the vehicle rear side, the vehicle speed is low and the momentum of water is low.

Hence, aging of the adhesive is more suppressed on the vehicle rear side than on the vehicle front side.

Accordingly, the peeling of the noise insulating material 50 can be suppressed on the vehicle rear side even in a configuration in which the noise insulating material 50 is locked by the fourth fixation portion 48 without use of the locking member 80.

Thus, it is possible to improve an effect of preventing the peeling of a vehicle rear side portion of the noise insulating material 50 while suppressing an increase in cost.

Moreover, in the present embodiment, one of the attachment brackets 60 is fixed to the vehicle body lower surface while being fixed to the fourth fixation portion 48.

This configuration can cause the attachment bracket 60 to catch the noise insulating material 50 and prevent it from falling to the outside of the vehicle even when the noise insulating material 50 peels off.

Accordingly, the noise insulating material 50 does not peel off from the underbody cover 1 unless both of portions of the noise insulating material 50 around the third fixation hole 52 and around the fourth fixation hole 53 break.

Thus, it is possible to improve the effect of preventing the peeling of the vehicle rear side portion of the noise insulating material 50 while suppressing an increase in cost.

Moreover, in the present embodiment, the reinforcement plate 70 is fixed to the first fixation portions 45a while extending in the vehicle front-rear direction.

This improves the rigidity of the first flange portion 45 and can further prevent the underbody cover 1 from sagging due to gravity.

Although the inner end portion of the locking member 80 is fixed to one of the first fixation portions 45a while the outer end portion of the locking member 80 is fixed to the third fixation portion 47 in the present embodiment, the configuration is not limited to such a form.

For example, the configuration may be such that the inner end portion of the locking member 80 is fixed to the third fixation portion 47 while the outer end portion of the locking member 80 is fixed to one of the second fixation portions 46a.

Operations and effects similar to those in the present embodiment can be obtained also in such a configuration.

Moreover, the configuration may be such that the inner end portion of the locking member 80 is fixed to one of the first fixation portions 45a, the outer end portion of the locking member 80 is fixed to one of the second fixation portions 46a, and an intermediate portion of the locking member 80 is fixed to the third fixation portion 47.

Operations and effects similar to those in the present embodiment can be obtained also in such a configuration.

Furthermore, the configuration may be such that the locking member 80 is formed of a plate material larger than the diameter of the third fixation hole 52, and is fixed to the third fixation portion 47 while being laid on the noise insulating material 50 from above.

Operations and effects similar to those in the present embodiment can be obtained also in such a configuration.

Moreover, the configuration may be such that the inner end portion of the locking member 80 is fixed to the lower surface of the vehicle body instead of being fixed to one of the first fixation portions 45a, and operations and effects similar to those in the present embodiment can be obtained also in such a configuration.

What is claimed is:

1. A vehicle lower structure comprising:
an underbody cover installed to cover a vehicle body lower surface from below;
a noise insulating material laid on an upper surface of the underbody cover; and
a locking member fixed to the underbody cover while being laid on the noise insulating material.

2. The vehicle lower structure according to claim 1, wherein
the underbody cover includes
a first fixation portion in a portion corresponding to a vehicle width direction inner side edge of the noise insulating material,
a second fixation portion in a portion corresponding to a vehicle width direction outer side edge of the noise insulating material, and
a third fixation portion in a portion overlapping the noise insulating material, and
the locking member is fixed to the third fixation portion while being fixed to at least one of the first fixation portion and the second fixation portion.

3. The vehicle lower structure according to claim 2, wherein
the underbody cover includes a fourth fixation portion protruding upward, behind the third fixation portion, and
the noise insulating material includes a fourth fixation hole in which the fourth fixation portion is inserted, in a portion overlapping the fourth fixation portion.

4. The vehicle lower structure according to claim 3, wherein the underbody cover is fixed to the vehicle body lower surface via an attachment bracket fixed to the fourth fixation portion.

5. The vehicle lower structure according to claim 2, wherein a reinforcement plate that extends in a vehicle front-rear direction is installed in at least one of the first fixation portion and the second fixation portion.
